(19) United States
(12) Patent Application Publication
(10) Pub. No.: US 2025/0306530 A1
(43) Pub. Date: Oct. 2, 2025

(54) PROCESS CARTRIDGE AND DEVELOPING CARTRIDGE

(71) Applicant: CANON KABUSHIKI KAISHA, Tokyo (JP)

(72) Inventors: NAOKI MATSUMARU, Shizuoka (JP); HIROKI SHIMIZU, Shizuoka (JP); TAKATOSHI HAMADA, Shizuoka (JP)

(21) Appl. No.: 19/090,717

(22) Filed: Mar. 26, 2025

(30) Foreign Application Priority Data
Mar. 29, 2024 (JP) 2024-057829

(51) Int. Cl. G03G 21/18

(52) U.S. Cl. CPC G03G 21/1871; G03G 21/1814

(57) ABSTRACT

A process cartridge includes a drum unit and a developing unit. The drum unit includes a swing support portion. The developing unit includes a swing supported portion supported by the swing support portion. A first and second contacts for the developing roller and a process member to receive power supply from outside respectively are provided on an end surface of the process cartridge. One of the swing support portion and the swing supported portion is an elongated hole having a longitudinal direction in a first direction, and the other is a protruding portion that engages with the elongated hole. The first and second contacts are arranged on an imaginary line extending in a second direction perpendicular to the first direction. The first contact and the second contact have a width that is greater in the first direction than in the second direction.

### BACKGROUND OF THE INVENTION

### Field of the Invention

The present invention relates to a process cartridge and a developing cartridge.

### Description of the Related Art

There are image forming apparatuses in which cartridges such as process cartridges and developing cartridges can be attached to and detached from the main body of the apparatus. A cartridge includes a developing roller and process members, such as a supply roller and a developing blade, which act on the developing roller. When a cartridge is attached to apparatus main body, a contact member of the cartridge comes into contact with an electrode of the apparatus main body, so that electricity (bias) is supplied from the apparatus main body to the developing roller and the process members. Japanese Patent Application Publication No. 2017-181703 describes a cartridge including a developing roller contact member, a supply roller contact member, and a developing blade contact member, which are arranged spaced apart from each other in a direction in which the photosensitive drum is opposed to the developing roller.

Furthermore, Japanese Patent No. 6950147 describes a process cartridge in which a developing unit is configured to be rotatable relative to a drum unit. The process cartridge includes a biasing member for biasing the developing roller toward a photosensitive drum, and a developing roller contact member. In this configuration, a technique is described in which the distance between the rotation center and the developing roller contact member is shorter than the distance between the rotation center and the biasing member, thereby reducing the size of the contact member.

### SUMMARY OF THE INVENTION

The present invention is a further development of the conventional configuration described above. More specifically, the present invention is to arrange a developing roller contact member and a process member contact member in a space-saving manner in a process cartridge or a developing cartridge in which a developing roller is movable between a contact position and a separated position relative to a photosensitive drum.

The present invention is a process cartridge comprising:
a drum unit including a photosensitive drum, a drum frame that supports the photosensitive drum such that the photosensitive drum is rotatable about a rotation axis, and a swing support portion;
a developing unit including a developing roller, a process member configured to act on the developing roller, a developing frame that rotatably supports the developing roller, and a swing supported portion supported by the swing support portion of the drum unit such that the developing roller can swing between a first position and a second position that is farther away from the photosensitive drum than the first position is; and
a first contact for the developing roller to receive power supply from outside of the process cartridge and a second contact for the process member to receive power supply from outside of the process cartridge, the first contact and the second contact being provided on an end surface of the process cartridge in a direction of the rotation axis,
wherein one of the swing support portion and the swing supported portion is an elongated hole having a longitudinal direction in a first direction as viewed in the direction of the rotation axis and the other of the swing support portion and the swing supported portion is a protruding portion that protrudes so as to engage with the elongated hole,
wherein the first contact and the second contact are arranged on an imaginary line extending in a second direction perpendicular to the first direction as viewed in the direction of the rotation axis, and
wherein the first contact has a width that is greater in the first direction than in the second direction and the second contact has a width that is greater in the first direction than in the second direction.

The present invention is a developing cartridge attachable to and detachable from an apparatus main body of an image forming apparatus including a photosensitive drum and a swing support portion, the developing cartridge comprising:
a developing unit including a developing roller, a process member configured to act on the developing roller, a developing frame that rotatably supports the developing roller, and a swing supported portion supported by the swing support portion of the apparatus main body such that the developing roller can swing between a first position and a second position that is farther away from the photosensitive drum than the first position is; and
a first contact for the developing roller to receive power supply from outside of the developing cartridge and a second contact for the process member to receive power supply from outside of the developing cartridge, the first contact and the second contact being provided on an end surface of the developing cartridge in a direction of a rotation axis of the photosensitive drum,
wherein one of the swing support portion and the swing supported portion is an elongated hole having a longitudinal direction in a first direction as viewed in the direction of the rotation axis and the other of the swing support portion and the swing supported portion is a protruding portion that protrudes so as to engage with the elongated hole,
wherein the first contact and the second contact are arranged on an imaginary line extending in a second direction perpendicular to the first direction as viewed in the direction of the rotation axis, and
wherein the first contact has a width that is greater in the first direction than in the second direction and the second contact has a width that is greater in the first direction than in the second direction.

Further features of the present invention will become apparent from the following description of exemplary embodiments with reference to the attached drawings.

### BRIEF DESCRIPTION OF THE DRAWINGS

FIG. 1 is a side view of a process cartridge of an embodiment as viewed from the non-drive side;

FIG. 2 is a schematic cross-sectional view of an image forming apparatus of the embodiment;

FIG. 3 is a cross-sectional view of the process cartridge of the embodiment;

FIG. 4 is a cross-sectional view of the image forming apparatus of the embodiment;

FIG. 5 is a cross-sectional view of the image forming apparatus of the embodiment;

FIG. 6 is a cross-sectional view of the image forming apparatus of the embodiment;

FIG. 7 is an exploded perspective view of a drum unit of the embodiment;

FIG. 8 is an exploded perspective view of a developing unit of the embodiment;

FIG. 9 is an assembly perspective view of the process cartridge of the embodiment;

FIG. 10 is a perspective view of the process cartridge of the embodiment;

FIG. 11A is a side view of a non-drive-side bearing of the embodiment;

FIG. 11B is a side view of the non-drive-side bearing of the embodiment;

FIG. 11C is a side view of the non-drive-side bearing of the embodiment;

FIG. 12 is a perspective view for illustrating a power supply path of a developing blade of the embodiment;

FIG. 13A is a diagram for illustrating the configuration of contact members of a remaining toner amount detection portion of the embodiment;

FIG. 13B is a diagram for illustrating a power supply path of the remaining toner amount detection portion of the embodiment;

FIG. 14 is a cross-sectional view of the process cartridge of the embodiment; and

FIG. 15 is a side view of the process cartridge of the embodiment as viewed from the drive side.

### DESCRIPTION OF THE EMBODIMENTS

Referring to the drawings and embodiments, the best mode for carrying out the present invention is described in detail below. However, the functions, materials, shapes, dimensions, relative arrangements, and the like of the components described in these embodiments may be modified as appropriate depending on the configuration of the apparatus to which the invention is applied and various conditions, and unless otherwise specified, it is not intended to limit the scope of the invention to those.

### First Embodiment

A first embodiment according to the present invention is now described referring to drawings. The first embodiment is an example of an image forming apparatus to which four process cartridges can be attached and detached. The number of process cartridges attached to the image forming apparatus is not limited to this and may be set as needed. Also, in the following embodiment, a laser beam printer is described as an example of an image forming apparatus.

### Outline of Image Forming Apparatus Configuration

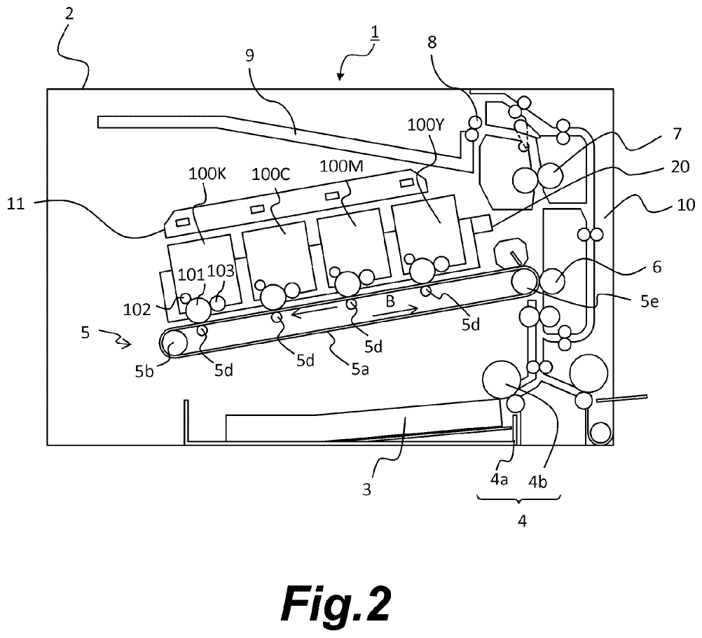

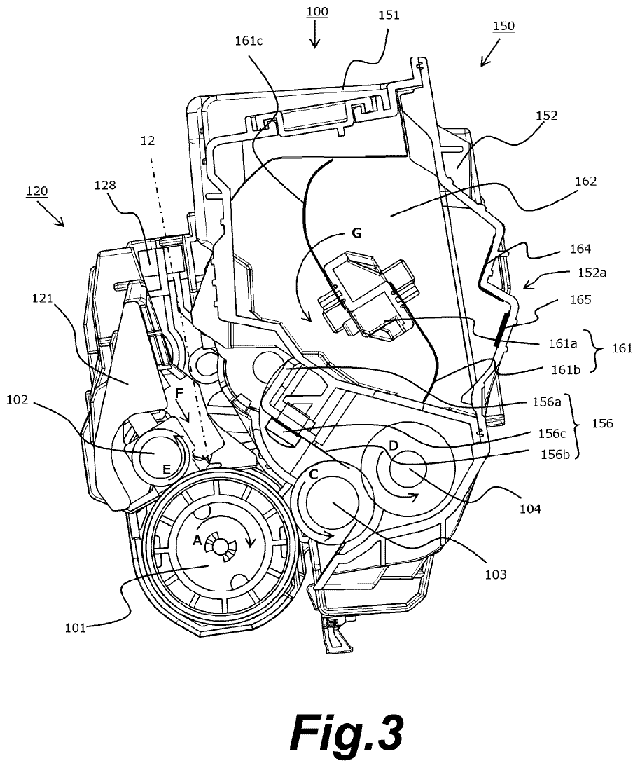

Referring to FIG. 2, the overall configuration of the image forming apparatus 1 of the present embodiment is now described. The image forming apparatus 1 includes an apparatus main body 2 and process cartridges 100. FIG. 2 is a schematic cross-sectional view of the image forming apparatus 1. FIG. 3 is a cross-sectional view of a process cartridge 100.

The image forming apparatus 1 is a four-color full-color laser beam printer that uses an electrophotographic process. The image forming apparatus 1 for forming a color image on a recording medium 3 is of a process cartridge type, in which process cartridges 100 are removably attached to the apparatus main body 2 and a color image is formed on the recording medium 3.

The side of the image forming apparatus 1 including a front door 10 is referred to as a front surface, and the side opposite to the front surface is referred to as a back (rear) surface. As viewed from the front side, the right side of the image forming apparatus 1 is referred to as a drive side, the left side as a non-drive side, the upper side as an upper surface, and the lower side as a lower surface. FIG. 2 is a cross-sectional view of the image forming apparatus 1 as viewed from the non-drive side. The front side in a P direction perpendicular to the drawing plane is the non-drive side of the image forming apparatus 1, the right side in the drawing is the front side of the image forming apparatus 1, and the rear side in a P direction perpendicular to the drawing plane is the drive side of the image forming apparatus 1.

As viewed in the rotation axis direction of a photosensitive drum 101, the drive side of the process cartridge 100 is the side at which a drum coupling member (photosensitive coupling member), which will be described below, is arranged. As viewed in the rotation axis direction of the developing roller 103 (developing member), the drive side is the side at which a developing coupling member is arranged.

The apparatus main body 2 includes a first process cartridge 100Y, a second process cartridge 100M, a third process cartridge 100C, and a fourth process cartridge 100K arranged in a substantially horizontal direction. The first to fourth process cartridges 100Y to 100K each have a similar electrophotographic process mechanism, but differ in the color and amount of the contained developer (hereinafter referred to as toner). As such, in the following description, the cartridges are described collectively without using the suffixes Y, M, C, and K where it is not necessary to distinguish them. A rotational driving force is transmitted to the process cartridge 100 from a drive output portion (described in detail below) of the apparatus main body 2, and a bias voltage (such as charging bias, supply bias, developing bias, remaining toner amount detection bias) is supplied (now shown) from a contact of the apparatus main body 2.

As shown in FIG. 3, the process cartridge 100 of the present embodiment includes a photosensitive drum 101 and a drum unit 120, which serves as a process means (process member) acting on the photosensitive drum 101 and includes a charging means. The drum unit 120 may also include a cleaning mean as a process means in addition to the charging means.

The process cartridge 100 also includes, as a process means (process member) acting on the photosensitive drum 101, a developing unit 150 including a developing means for developing the electrostatic latent image on the photosensitive drum 101. The drum unit 120 and the developing unit 150 are coupled to each other. A detailed description of the process cartridge 100 will be given below.

The first process cartridge 100Y contains yellow (Y) toner in the developing frame and forms a yellow toner image on the surface of the photosensitive drum 101. The second process cartridge 100M contains magenta (M) toner in the developing frame and forms a magenta toner image on the surface of the photosensitive drum 101. The third process cartridge 100C contains cyan (C) toner in the developing frame and forms a cyan toner image on the surface of the photosensitive drum 101. The fourth process cartridge 100K contains black (K) toner in the developing frame and forms a black toner image on the surface of the photosensitive drum 101.

A laser scanner unit 11 serving as an exposure means is provided above the process cartridges 100. The laser scanner unit 11 outputs a laser beam 12 corresponding to image information. The laser beam 12 passes through an exposure window 128 of the process cartridge 100 and performs scanning exposure on the surface of the photosensitive drum 101.

An intermediate transfer unit 5 as a transfer member is provided below the process cartridge 100. The intermediate transfer unit 5 includes a driver roller 5e, a tension roller 5b, and a flexible transfer belt 5a, which runs around these rollers. The lower surface of the photosensitive drum 101 of the process cartridge 100 is in contact with the upper surface of the transfer belt 5a. This contact portion serves as a primary transfer portion. Primary transfer rollers 5d are aligned with the photosensitive drums 101 on the inner side of the transfer belt 5a.

A secondary transfer roller 6 is in contact with the driver roller 5e through the transfer belt 5a. The contact portion between the transfer belt 5a and the secondary transfer roller 6 serves as a secondary transfer portion. A feeding unit 4 is provided below the intermediate transfer unit 5. The feeding unit 4 includes a paper feed tray 4a, which stores stacked recording media 3, and a paper feed roller 4b. A fixing apparatus 7 and a paper discharge apparatus 8 are provided in the upper right section of the apparatus main body 2 as viewed in FIG. 2. The upper surface of the apparatus main body 2 serves as a paper discharge tray 9. A fixing means of the fixing apparatus 7 fixes the toner image on the recording medium 3, which is then discharged onto the paper discharge tray 9.

### Image Forming Operation

The operation for forming a full-color image is as follows. The photosensitive drum 101 of the process cartridge 100 is driven to rotate at a predetermined speed (in the direction of arrow A in FIG. 3). The transfer belt 5a is also driven to rotate in the forward direction (the direction of arrow B in FIG. 2) relative to the rotation of the photosensitive drum 101 at a speed corresponding to the speed of the photosensitive drum 101.

The laser scanner unit 11 is also driven. In synchronization with the driving of the laser scanner unit 11, the charging roller 102 uniformly charges the surface of the photosensitive drum 101 to a predetermined polarity and potential in each process cartridge 100. According to an image signal of each color, the laser scanner unit 11 performs scanning exposure on the surface of each photosensitive drum 101 with the laser beam 12.

This forms an electrostatic latent image corresponding to the image signal on the surface of each photosensitive drum 101. The formed electrostatic latent image is developed by the developing roller 103, which is driven to rotate at a predetermined speed in the forward direction (the direction of arrow C in FIG. 3) relative to the rotation of the photosensitive drum 101.

Through the electrophotographic image forming process operation as described above, a yellow toner image corresponding to the yellow component of the full-color image is formed on the photosensitive drum 101 of the first process cartridge 100Y. Then, this toner image is transferred onto the transfer belt 5a as primary transfer. Similarly, a magenta toner image corresponding to the magenta component of the full-color image is formed on the photosensitive drum 101 of the second process cartridge 100M. Then, this toner image is superimposed on the yellow toner image, which has been transferred on the transfer belt 5a, as primary transfer. Similarly, a cyan toner image corresponding to the cyan component of the full-color image is formed on the photosensitive drum 101 of the third process cartridge 100C. Then, this toner image is superimposed on the yellow-colored and magenta-colored toner images, which have been transferred on the transfer belt 5a, as primary transfer. Similarly, a black toner image corresponding to the black component of the full-color image is formed on the photosensitive drum 101 of the fourth process cartridge 100K. Then, this toner image is superimposed on the yellow, magenta, and cyan toner images, which have been transferred on the transfer belt 5a, as primary transfer. In this manner, unfixed full-color toner images of four colors of yellow, magenta, cyan, and black are formed on the transfer belt 5a.

Meanwhile, the recording media 3 are separately fed one by one at predetermined control timing. A recording medium 3 is introduced into the secondary transfer portion, which is the contact portion between the secondary transfer roller 6 and the transfer belt 5a, at predetermined control timing. As a result, as the recording medium 3 is being transported to the secondary transfer portion, the toner images of the four colors superimposed on the transfer belt 5a are collectively transferred to the surface of the recording medium 3 in sequence.

### Outline of Process Cartridge Attachment/Detachment Configuration

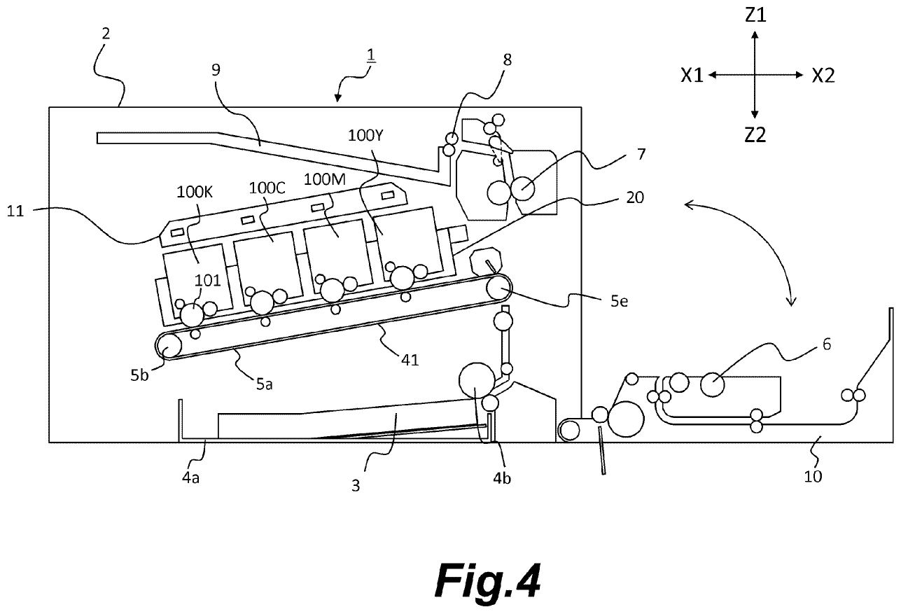

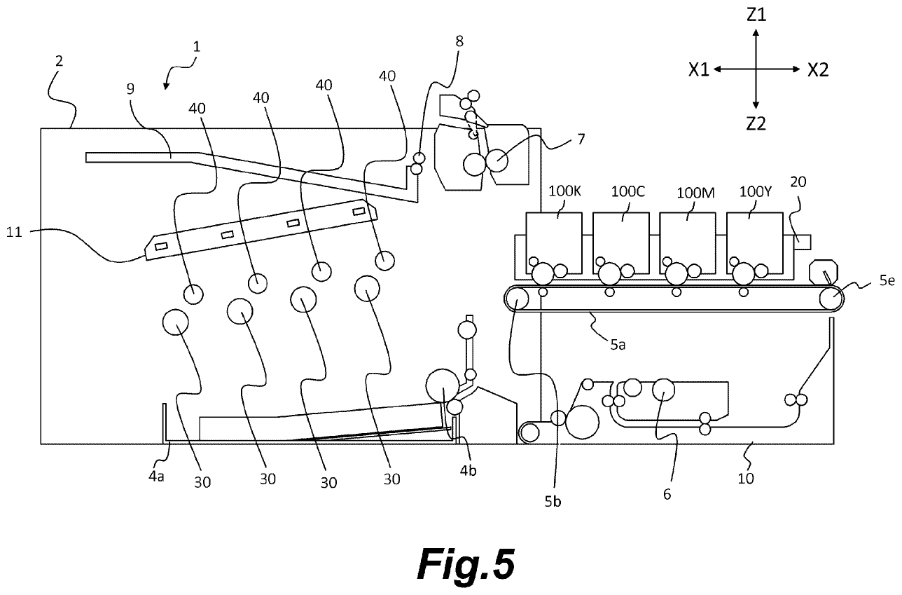

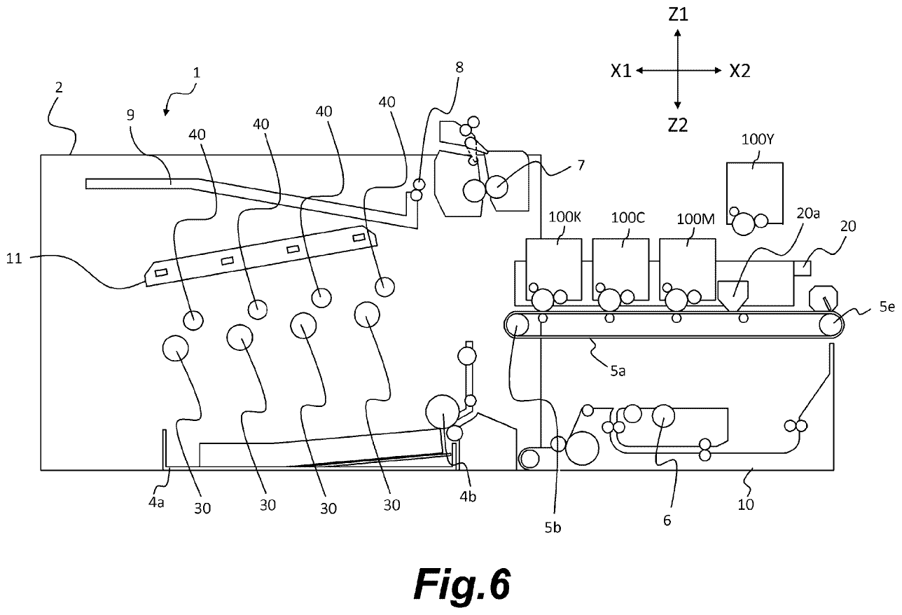

Further details of the configuration of the apparatus main body are now described below. Referring to FIGS. 4 to 6, a cartridge tray (hereinafter referred to as a tray) 20 that supports the process cartridges 100 is described in further detail. FIG. 4 is a cross-sectional view of the image forming apparatus 1 in a state in which the front door 10 is open and the tray 20 is located inside of the apparatus main body 2. FIG. 5 is a cross-sectional view of the image forming apparatus 1 in a state in which the front door 10 is open, the tray 20 is located outside of the apparatus main body 2, and the process cartridges 100 are housed inside of the tray 20. FIG. 6 is a cross-sectional view of the image forming apparatus 1 in a state in which the front door 10 is open, the tray 20 is located outside of the apparatus main body 2, and a process cartridge 100 is removed from the tray 20.

As shown in FIGS. 4 and 5, the tray 20 is movable relative to the apparatus main body 2 in the direction of arrow X1 (pushing direction) and the direction of arrow X2 (pulling direction), which are substantially horizontal. That is, the tray 20 is provided such that it can be pulled out of and pushed into the apparatus main body 2. When the apparatus main body 2 is installed on a horizontal plane, the tray 20 is configured to be movable substantially in the horizontal directions. The state in which the tray 20 is inside of the apparatus main body 2 with the front door 10 open (the state in FIG. 4) is referred to as an inside position. The state in which the tray 20 is outside of the apparatus main body 2 (the state in FIG. 5) is referred to as an outside position. At the inside and outside positions, the photosensitive drums 101 are separated from the transfer belt 5a.

As shown in FIG. 6, the tray 20 includes an attachment portion 20a to which the first process cartridge 100Y can be removably attached at the outside position. The tray 20 also includes attachment portions 20a to which the second process cartridge 100M, the third process cartridge 100C, and the fourth process cartridge 100K can be removably attached in the same manner. As the tray 20 moves, the process cartridges 100 move into the apparatus main body 2 while placed on the attachment portions 20a. In this embodiment, closing the front door 10 causes a link mechanism (not shown) to lift the intermediate transfer unit 5 in the direction of arrow Z1 to the position for image formation (the position at which the transfer belt 5a is in contact with photosensitive drums 101). Opening the front door 10 will lower the intermediate transfer unit 5 in the direction of arrow Z2, so that the transfer belt 5a is separated from the photosensitive drums 101.

As described above, the tray 20 allows the multiple process cartridges 100 to be moved together to a position in the apparatus main body 2 at which image formation is possible, and also allows them to be pulled out of the apparatus main body 2 together.

### Overall Configuration of Process Cartridge

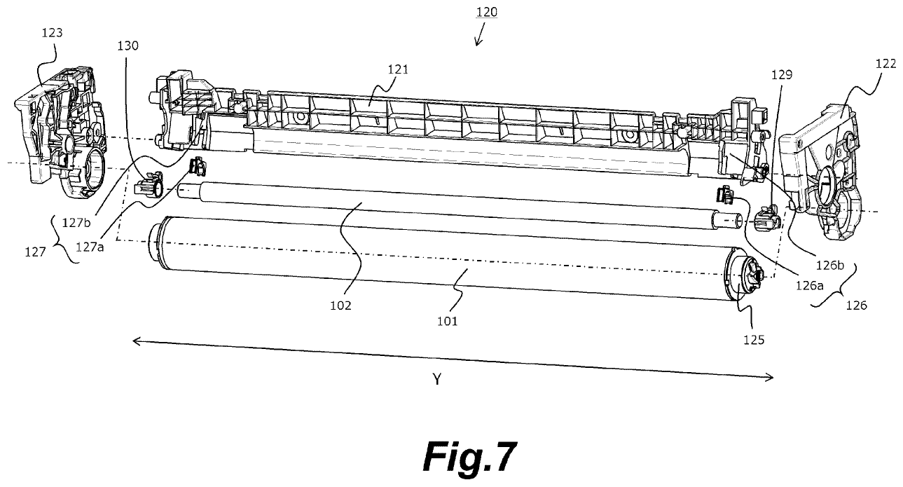

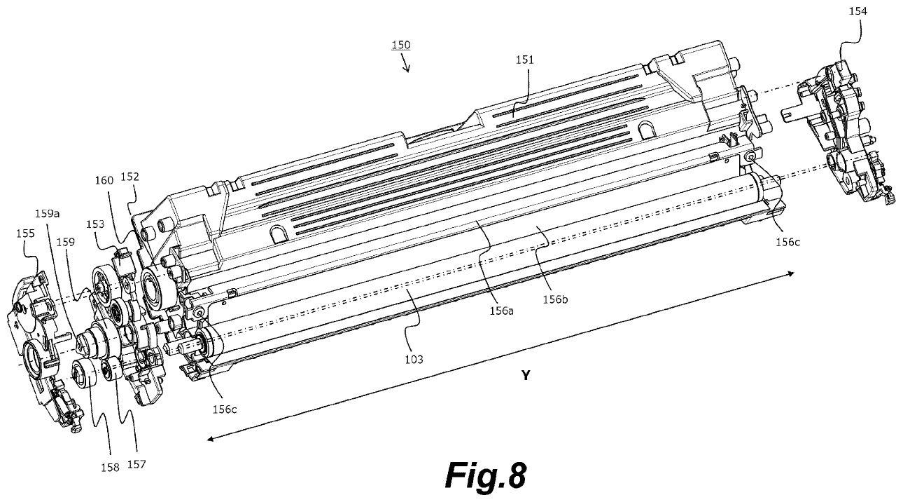

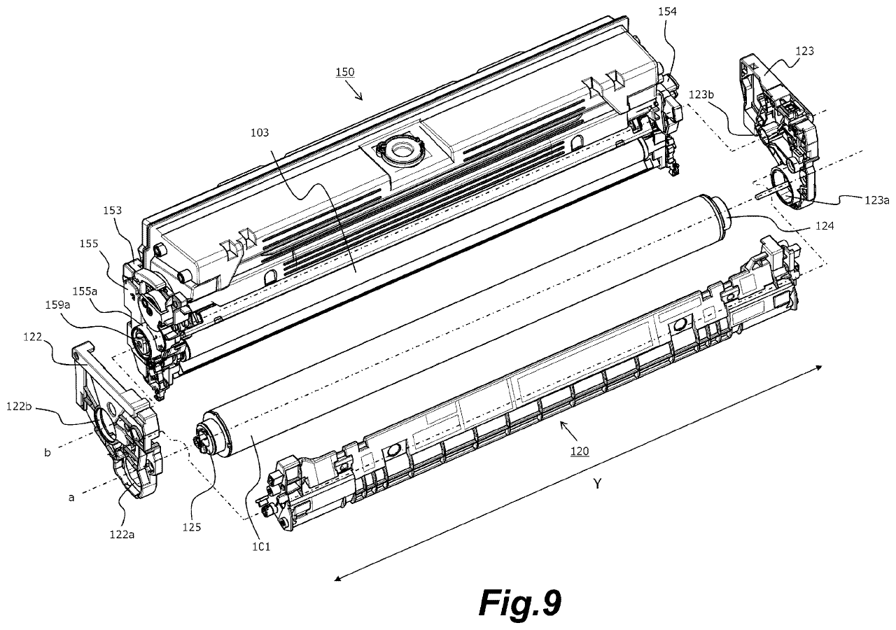

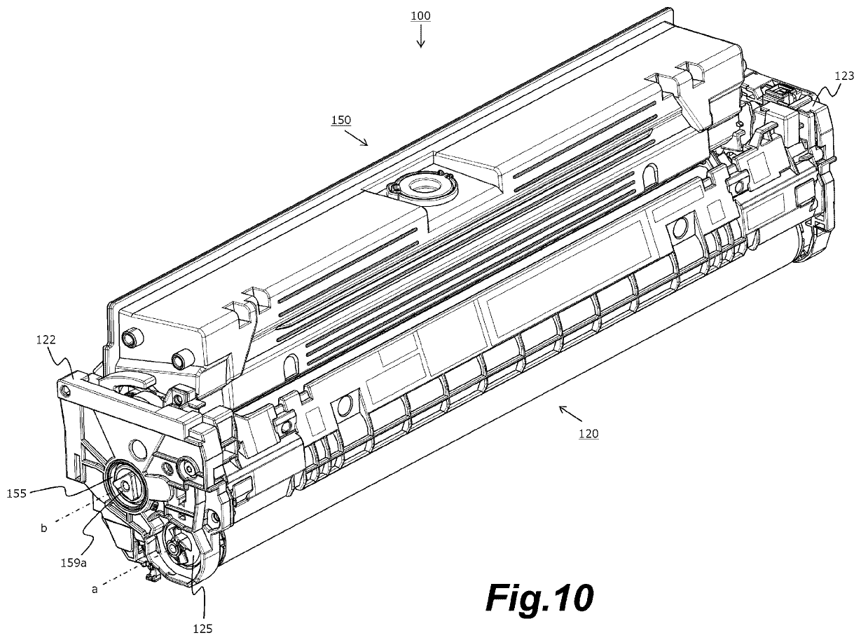

Referring to FIGS. 7 to 10, the configuration of the process cartridge is now described. FIG. 7 is an exploded perspective view of a drum unit 120. FIG. 8 is an exploded perspective view of a developing unit 150. FIG. 9 is an assembly perspective view of the process cartridge 100 as viewed from the drive side, which is one end side in the axial direction of the photosensitive drum 101. FIG. 10 is a perspective view of the process cartridge 100 as viewed from the drive side.

The process cartridge 100 includes a photosensitive drum 101 and process members (process components) that act on the photosensitive drum 101. The process members include a charging roller 102 as a charging means for charging the photosensitive drum 101, a developing roller 103 as a developing means for developing a latent image formed on the photosensitive drum 101, and the like. The process cartridge 100 is divided into a drum unit 120 and a developing unit 150. In the following description, the longitudinal directions of the drum unit 120 and the process cartridge 100 are directions substantially parallel to a rotation axis a of the photosensitive drum 101, and the longitudinal direction of the developing unit 150 is substantially parallel to the rotation axis of the developing roller 103 (FIG. 9).

### Drum Unit Configuration

As shown in FIGS. 7 and 9, the drum unit 120 includes a photosensitive drum 101, a charging roller 102, a drum frame 121, and the like. The drum unit 120 includes a drive-side charging roller bearing unit 126, which is arranged at the drive-side end portion of the charging roller 102, and a non-drive-side charging roller bearing unit 127, which is arranged at the non-drive-side end portion. The charging roller 102 is rotatably supported by a drive-side charging roller bearing 126a and a non-drive-side charging roller bearing 127a, and is biased toward (in the direction of arrow F in FIG. 3) the photosensitive drum 101 by springs 126b and 127b. A drive-side charging roller spacing member 129 and a non-drive-side charging roller spacing member 130 are attached to the respective ends in the longitudinal direction. In the initial shipping state, the charging roller 102 and the photosensitive drum 101 are separated from each other. During use, the separated state is canceled by the rotation of the photosensitive drum 101. The drum frame 121 supports the photosensitive drum 101 rotatably about the rotation axis.

The photosensitive drum 101 is rotatably supported by a drive-side cover member 122 and a non-drive-side cover member 123, which are provided at opposite longitudinal ends of the process cartridge 100. As shown in FIG. 9, a coupling member 125 for transmitting a driving force to the photosensitive drum 101 is provided at one longitudinal end of the photosensitive drum 101. The coupling member 125 engages with a main-body-side drum drive coupling 30 (see FIGS. 5 and 6), which serves as a drum drive output portion of the apparatus main body 2. The driving force of a drive motor (not shown) of the apparatus main body 2 is transmitted to the photosensitive drum 101, rotating the photosensitive drum 101 in the direction of arrow A in FIG. 3. The photosensitive drum 101 also includes a drum flange 124 at the other longitudinal end. The drive-side charging roller bearing 126a and the non-drive-side charging roller bearing 127a supporting the charging roller 102 are supported by the drum frame 121 such that the charging roller 102 can be in contact with and rotated by the photosensitive drum 101 (in the direction of arrow E in FIG. 3).

### Developing Unit Configuration

As shown in FIGS. 3 and 8, the developing unit 150 includes a developing roller 103, a supply roller 104, a developing blade 156, a developing frame, and the like. The supply roller 104 supplies developer to the developing roller 103. The developing frame consists of a first developing frame 151 and a second developing frame 152. The first and second developing frames 151 and 152 are joined together by ultrasonic welding, for example. The developing frame includes a toner storage portion 162 storing toner to be supplied to the developing roller 103. The developing frame rotatably supports the core metal portions of the developing roller 103 and the supply roller 104 through a drive-side bearing 153 and a non-drive-side bearing 154, and holds the developing blade 156, which regulates the layer thickness of the toner on the surface of the developing roller 103. The first developing frame 151, the second developing frame 152, the drive-side bearing 153, and the non-drive-side bearing 154 may be collectively regarded as a developing frame that rotatably supports the developing roller 103 and the supply roller 104 and also supports the developing blade 156. The supply roller 104 and the developing blade 156 are examples of process members configured to act on the developing roller.

The developing blade 156 is formed by welding or otherwise joining an elastic member 156b, which is a metal sheet having a thickness of about 0.1 mm, to a support member 156a, which is a metal material having an L-shaped cross-section. The developing blade 156 is fixed to the developing frame with fixing screws 156c at two locations on opposite longitudinal ends.

A developing drive input gear 159 for transmitting a driving force to the developing unit 150 is provided at one longitudinal end of the developing unit 150. The developing drive input gear 159 includes a developing input coupling portion 159a, which is driven by a main-body-side developing drive coupling 40 (see FIGS. 5 and 6) of the apparatus main body 2. The driving force of the drive motor (not shown) of the apparatus main body 2 is input to the developing unit 150.

The driving force input to the developing unit 150 is transmitted to a developing roller gear 157 and a supply roller gear 158, thus driving and rotating the developing roller 103 in the direction of arrow C in FIG. 3 and the supply roller 104 in the direction of arrow D. The driving force is also transmitted to a stirring gear 160, thereby rotating a stirring member 161 in the direction of G in FIG. 3 and stirring the toner in the toner storage portion 162. The stirring member 161 includes a rotation shaft 161a, which is parallel to the rotation axis of the developing roller 103, and a first stirring sheet 161b and a second stirring sheet 161c, which are flexible sheets serving as transport members. As the rotation shaft 161a rotates, the first and second stirring sheets 161b and 161c also rotate and thus stir the toner.

The second developing frame 152 includes a remaining toner amount detection portion 152a for detecting the amount of toner remaining in the toner storage portion 162 (inside of the storage portion). In the remaining toner amount detection portion 152a, a flexible conductive sheet 164, which is a first conductor, and a conductive sheet 165, which is a second conductor, are fixed to the inner side of the toner storage portion 162 by insert molding.

The stirring member 161 transports toner to the remaining toner amount detection portion 152a in an amount corresponding to the amount of toner remaining in the toner storage portion 162. A remaining amount detection bias is applied to the conductive sheets 164 and 165 from the apparatus main body 2, and the remaining toner amount can be detected by detecting the electrostatic capacitance according to the amount of toner transported to the remaining toner amount detection portion 152a. Also, a developing cover member 155, which supports and covers the developing drive input gear 159, is provided at one longitudinal end of the developing unit 150.

### Coupling of Drum Unit and Developing Unit

Referring to FIG. 9, the coupling of the drum unit 120 and the developing unit 150 is now described. The drum unit 120 and the developing unit 150 are coupled by the drive-side cover member 122 and the non-drive-side cover member 123 provided at opposite longitudinal ends of the process cartridge 100.

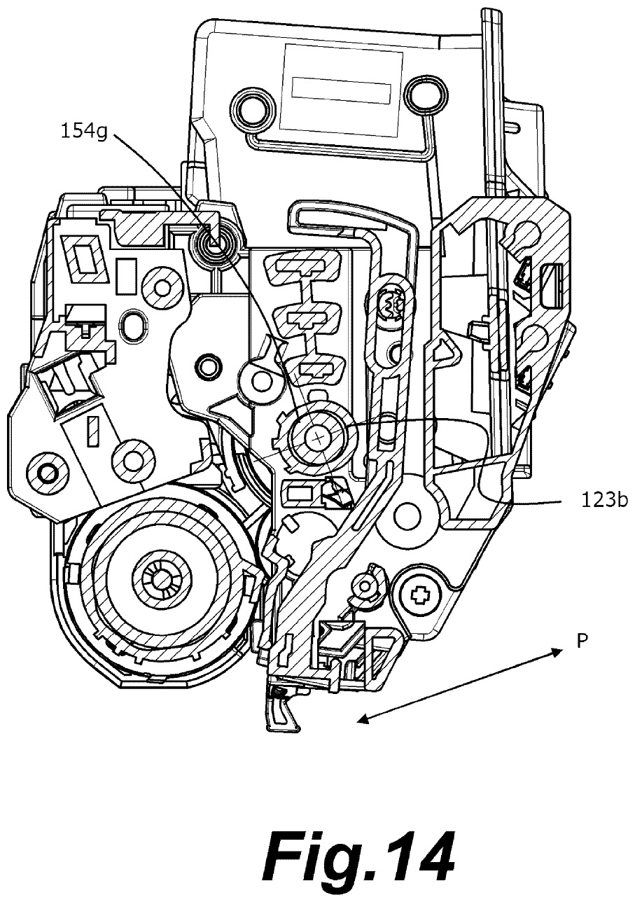

The drive-side cover member 122 provided at one longitudinal end of the process cartridge 100 has a developing unit support hole 122b for movably supporting the developing unit 150. As will be described below, the developing unit support hole 122b supports the developing unit 150 so as to be rotatable about an axis of rotation represented by axis b. The non-drive-side cover member 123 provided at the other longitudinal end of the process cartridge 100 includes a developing unit support hole 123b for movably supporting the developing unit 150. As will be described below, the developing unit support hole 123b supports the developing unit 150 such that the developing unit 150 is rotatable about the axis b and is also capable of linear motion (linearly movable) in the first direction (P direction). At one end, the outer diameter section of a cylindrical portion 155a of the developing cover member 155 is fitted into the developing unit support hole 122b of the drive-side cover member 122. At the other end, the outer diameter section of a cylindrical portion 154g (see FIG. 14) of the non-drive-side bearing 154 is fitted into the developing unit support hole 123b of the non-drive-side cover member 123. The developing unit support holes 122b and 123b are swing support portions that allow the drum unit 120 to support the developing unit 150 swingably. The cylindrical portions 155a and 154g are swing supported portions that are swingably supported by the swing support portions of the drum unit 120.

The drive-side cover member 122 and the non-drive-side cover member 123 include drum support holes 122a and 123a, respectively, for rotatably supporting the photosensitive drum 101. The opposite longitudinal ends of the photosensitive drum 101 are fitted into the drum support hole 122a of the drive-side cover member 122 and the drum support hole 123a of the non-drive-side cover member 123.

The drive-side cover member 122 and the non-drive-side cover member 123 are fixed to the drum frame 121 of the drum unit 120 by screws, adhesive, or the like (not shown). As a result, the developing unit 150 is supported by the drive-side cover member 122 and the non-drive-side cover member 123 so as to be movable relative to the drum unit 120 (photosensitive drum 101). As described below, the directions in which the developing unit 150 moves relative to the drum unit 120 include the direction of the rotation about the axis b and the direction of linear motion in the first direction (P direction). The drum frame 121, the drive-side cover member 122, and the non-drive-side cover member 123 may be collectively regarded as a drum frame that rotatably supports the photosensitive drum 101.

### Description of Contact Member Configuration and Power Supply Path of Process Components

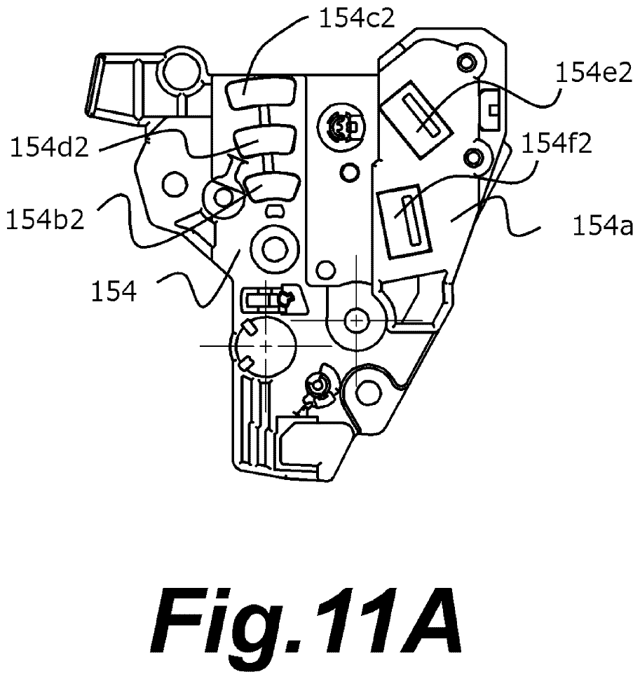

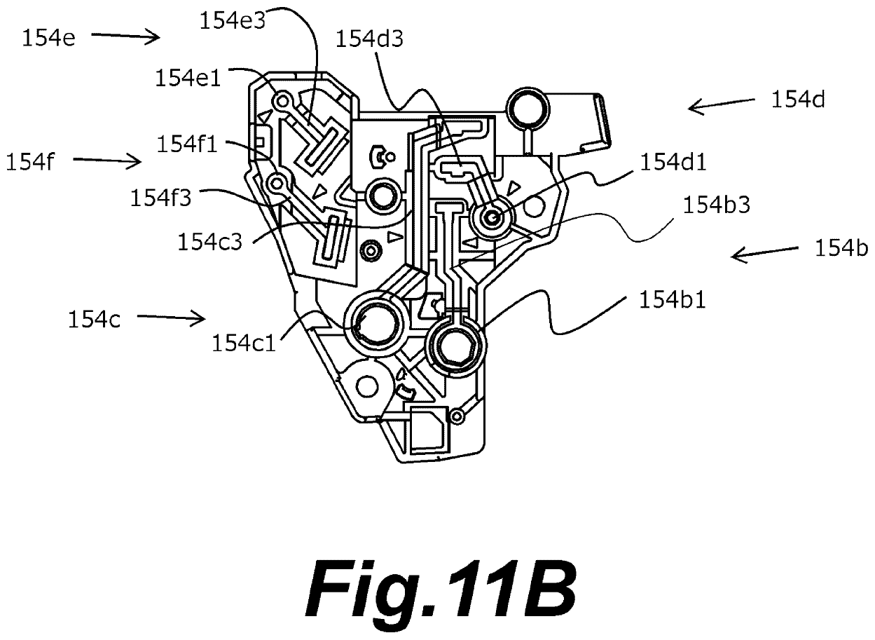

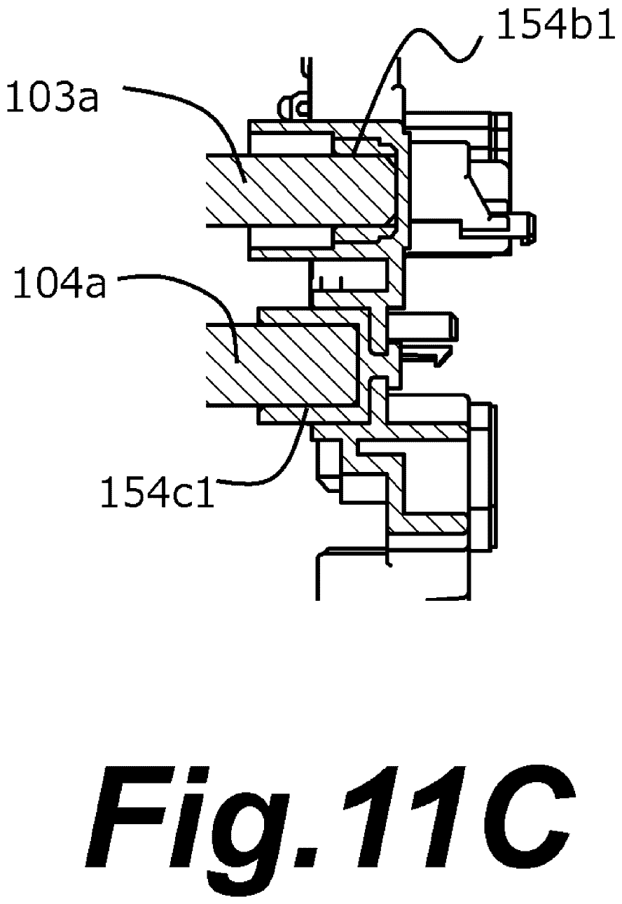

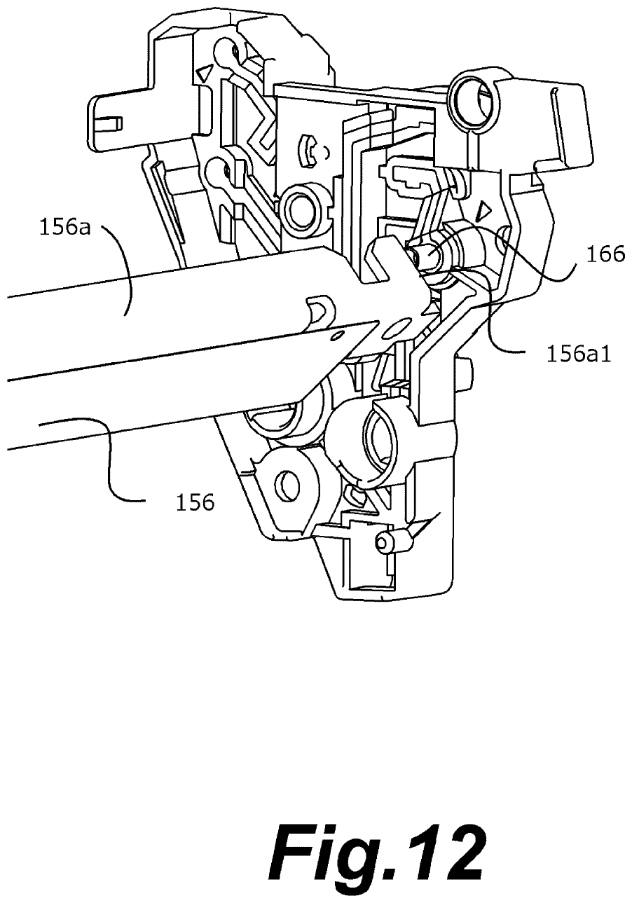

The configuration of the contact members of the process components of the embodiment is now described. Referring to FIGS. 11A to 11C, and 12, the non-drive-side bearing 154 including contact members is first described. FIG. 11A is a diagram of the non-drive-side bearing 154 as viewed from the non-drive side, and FIG. 11B is a diagram as viewed from the drive side. FIG. 11C is a cross-sectional view of the developing roller 103, the supply roller 104, and a slide portion of the non-drive-side bearing 154, which rotatably supports these rollers, taken in the longitudinal direction. FIG. 12 is a perspective view for illustrating the power supply path of the developing blade 156.

The non-drive-side bearing 154 includes a base member 154a, which is made of PC+ABS and the like, and contact members, which are fixed to the base member 154a by two-color molding and are made of conductive resin. The contact members are provided on the non-drive-side bearing 154, which forms an end surface of the process cartridge 100 in the direction of the rotation axis of the photosensitive drum 101. The contact members include a first contact, a second contact, and a third contact to allow the developing roller 103 and the process members configured to act on the developing roller 103 to individually receive power supply from outside of the process cartridge 100. The developing blade 156, which is configured to regulate the layer thickness of the developer carried on the surface of the developing roller 103, and the supply roller 104, which is configured to supply the developer to the developing roller 103, are examples of process members. In the present embodiment, the contact members include a developing roller contact member 154b, a supply roller contact member 154c, a developing blade contact member 154d, a first detection contact member 154e, and a second detection contact member 154f. The developing roller contact member 154b is an example of the first contact, the developing blade contact member 154d is an example of the second contact, and the supply roller contact member 154c is an example of the third contact. The supply roller contact member 154c and the developing blade contact member 154d can come into contact with electrodes of the apparatus main body 2 with the process cartridge 100 attached to the apparatus main body 2.

The developing roller contact member 154b is electrically connected to the developing roller 103, and can come into contact with an electrode of the apparatus main body 2 corresponding to the developing roller contact member 154b with the process cartridge 100 attached to the apparatus main body 2. The supply roller contact member 154c is electrically connected to the supply roller 104, and can come into contact with an electrode of the apparatus main body 2 corresponding to the supply roller contact member 154c with the process cartridge 100 attached to the apparatus main body 2. The developing blade contact member 154d is electrically connected to the developing blade 156, and can come into contact with an electrode of the apparatus main body 2 corresponding to the developing blade contact member 154d with the process cartridge 100 attached to the apparatus main body 2. The first detection contact member 154e (fourth contact) is electrically connected to the conductive sheet 164, which is the first conductor, and can come into contact with an electrode of the apparatus main body 2 corresponding to the first detection contact member 154e with the process cartridge 100 attached to the apparatus main body 2. The second detection contact member 154f (fifth contact) is electrically connected to the conductive sheet 165, which is the second conductor, and can come into contact with an electrode of the apparatus main body 2 corresponding to the second detection contact member 154f with the process cartridge 100 attached to the apparatus main body 2.

The developing roller contact member 154b includes a developing roller support portion 154b1, a contact portion 154b2, and a flow passage portion 154b3 connecting them. The developing roller support portion 154b1 supports a developing roller core metal portion 103a (FIG. 11C) at the end portion of the developing roller 103 in the longitudinal direction. The contact portion 154b2 comes into contact with an electrode (for example, a contact spring) corresponding to the developing roller contact member 154b for applying a developing roller bias from the apparatus main body 2 to the developing roller 103. The developing bias applied via the electrode of the apparatus main body 2 is supplied to the developing roller 103 via the contact portion 154b2, the flow passage portion 154b3, and the developing roller support portion 154b1.

The supply roller contact member 154c includes a supply roller support portion 154c1, a supply roller contact portion 154c2, and a flow passage portion 154c3 connecting them. The supply roller support portion 154cl supports a supply roller core metal portion 104a (FIG. 11C) at the end portion of the supply roller 104 in the longitudinal direction. The supply roller contact portion 154c2 comes into contact with an electrode (for example, a contact spring) corresponding to the supply roller contact member 154c for applying a supply roller bias from the apparatus main body 2 to the supply roller 104. The supply roller bias applied via the electrode of the apparatus main body 2 is supplied to the supply roller 104 via the supply roller contact portion 154c2, the flow passage portion 154c3, and the supply roller support portion 154c1.

To enhance the stability of the electrical contact path, a conductive lubricant is applied to the developing roller support portion 154b1 and the developing roller core metal portion 103a, and to the supply roller support portion 154cl and the supply roller core metal portion 104a.

The developing blade contact member 154d includes a developing blade contact spring support portion 154d1, a developing blade contact portion 154d2, and a flow passage portion 154d3 connecting them. The developing blade contact spring support portion 154d1 supports a developing blade contact spring 166, which will be described below. The developing blade contact portion 154d2 comes into contact with an electrode (for example, a contact spring) corresponding to the developing blade contact member 154d for applying a developing blade bias from the apparatus main body 2 to the developing blade 156.

The developing blade contact spring 166 is placed such that one end portion is pressed into and supported by the developing blade contact spring support portion 154d1, and the other end portion abuts a non-drive side end portion 156al of the support member 156a with a predetermined pressure (FIG. 12). The non-drive side end portion 156a1 of the support member 156a serves as a cutting surface during the manufacturing of the support member 156a. Thus, to enhance the stability of the electrical contact path, a conductive lubricant is applied to the contact portion between the developing blade contact spring 166 and the support member 156a.

The developing blade bias applied via an electrode (for example, a contact spring) for applying the developing blade bias of the apparatus main body 2 is supplied to the developing blade 156 via the developing blade contact portion 154d2, the flow passage portion 154d3, and the developing blade contact spring 166.

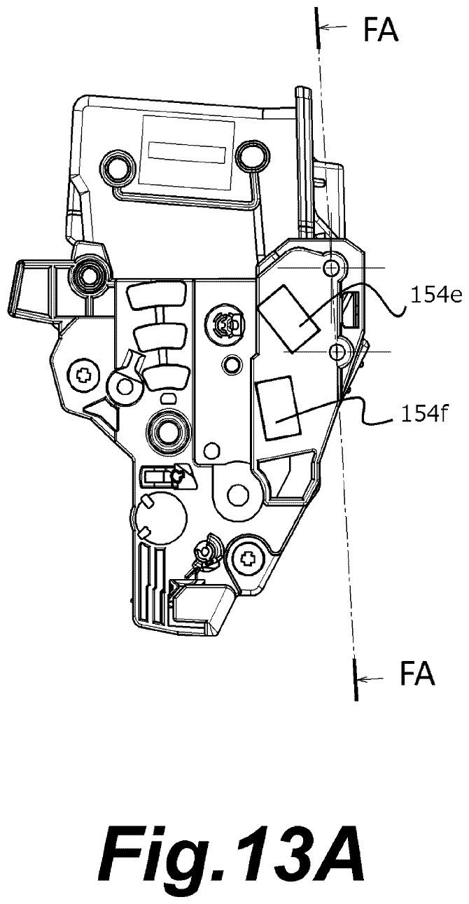

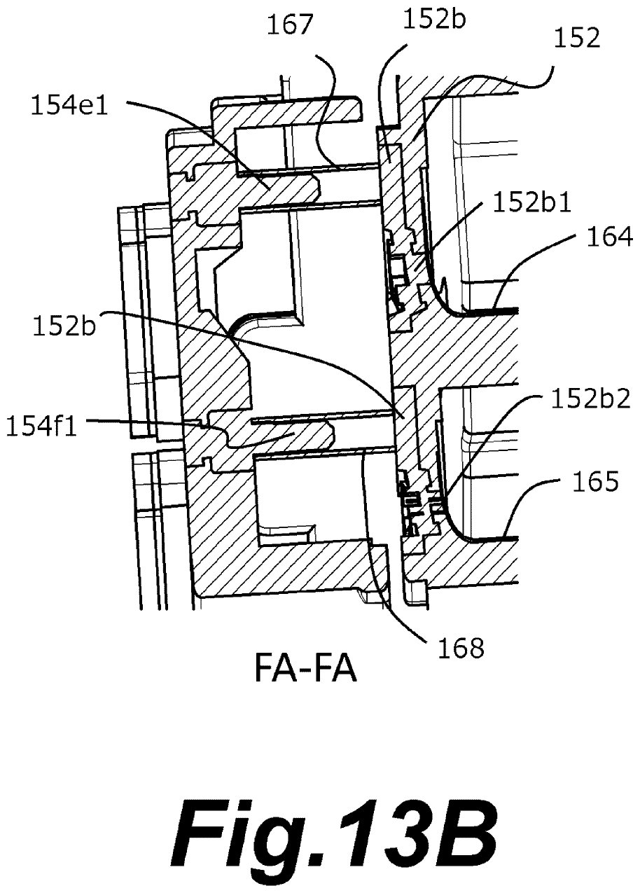

Referring to FIGS. 13A and 13B, the configuration of the contact portions and the power supply path of the remaining toner amount detection portion 152a are now described. FIG. 13A is a side view of the developing unit 150 as viewed from the non-drive side. For convenience of description, only the components concerning the contact configuration of the remaining toner amount detection portion 152a are shown. FIG. 13B is a cross-sectional view taken along line FA-FA in FIG. 13A, and is a diagram for illustrating the power supply path of the remaining toner amount detection portion 152a.

The first detection contact member 154e and the second detection contact member 154f include remaining amount detection contact spring support portions 154e1 and 154f1, remaining toner amount detection contact portions 154e2 and 154f2, and flow passage portions 154e3 and 154f3 connecting them (FIGS. 11A to 11C). The remaining amount detection contact spring support portions 154e1 and 154f1 support remaining amount detection contact springs 167 and 168, which will be described below. The remaining toner amount detection contact portions 154e2 and 154f2 come into contact with electrodes (for example, contact springs) corresponding to the first and second detection contact members 154e and 154f for applying a remaining toner amount detection bias from the apparatus main body 2 to the remaining toner amount detection portion 152a.

As shown in FIG. 13B, the remaining amount detection contact springs 167 and 168 are each placed such that the remaining amount detection contact spring support portion 154e1, 154f1 is press-fitted in and thus supports one end portion, and that the other end portion abuts a conductive member 152b, which is provided in the second developing frame 152, with a predetermined pressure. Each conductive member 152b is molded in the second developing frame 152 by two-color molding, and includes a connection portion 152b1, 152b2 for electrical connection to the conductive sheet 164, 165.

The remaining toner amount detection bias applied from electrodes of the apparatus main body 2 is supplied to the conductive sheets 164 and 165 via the remaining toner amount detection contact portions 154e2 and 154f2, the flow passage portions 154e3 and 154f3, the remaining amount detection contact springs 167 and 168, the conductive member 152b, and the connection portions 152b1 and 152b2.

Electrodes (contact springs) (not shown) provided in the apparatus main body 2 are configured to come into and out of contact with the contact members provided on the cartridges in conjunction with the opening and closing operations of the front door 10 while the process cartridge 100 attached to the tray 20 is attached to the apparatus main body 2 (FIG. 4).

### Developing Unit Moving Direction and Contact Member Arrangement

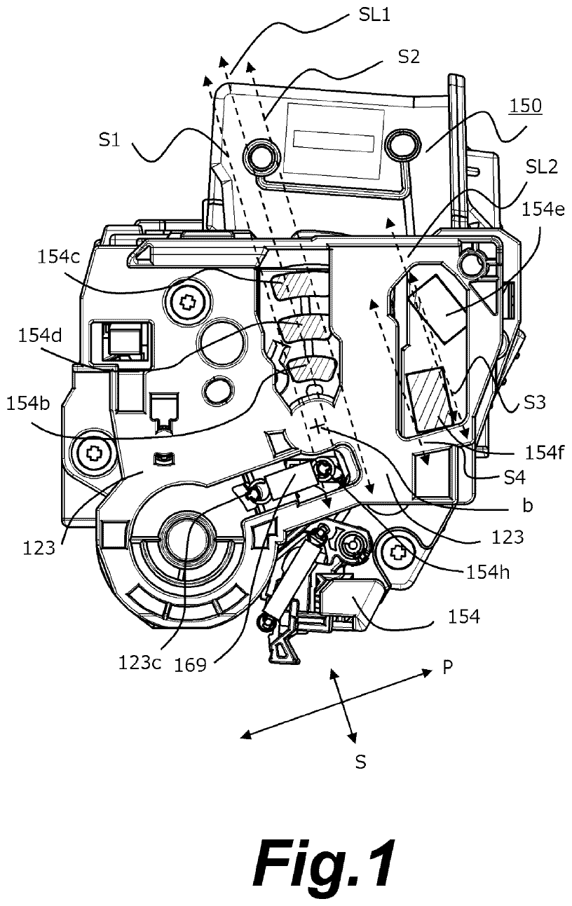

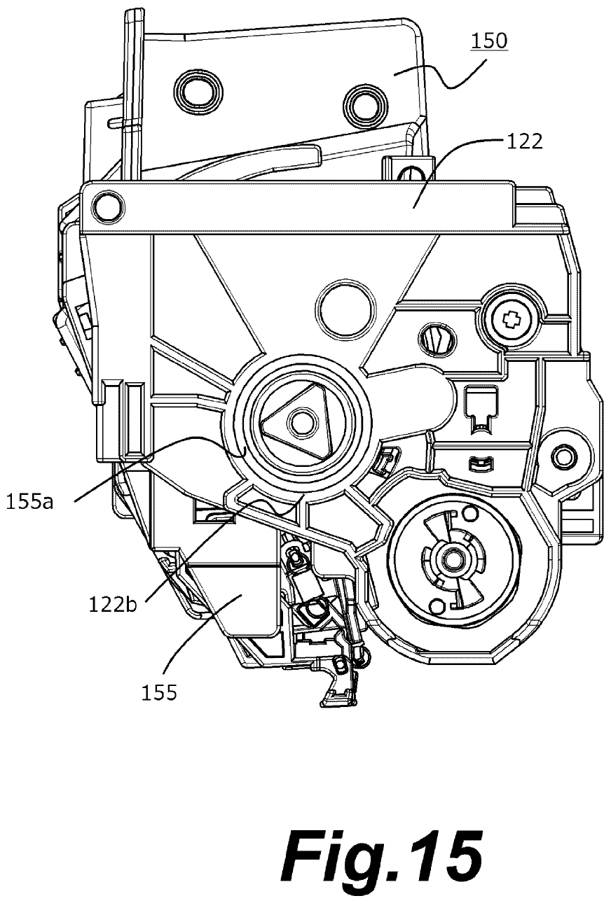

Referring to FIGS. 1, 14, and 15, the moving direction of the developing unit 150 and the arrangement of the contact members are now described. FIG. 1 is a side view of the process cartridge 100 as viewed from the non-drive side, and FIG. 14 is a cross-sectional view of the process cartridge 100 at a longitudinal position where the non-drive-side cover member 123 supports the non-drive-side bearing 154 of the developing unit 150. FIG. 15 is a side view of the process cartridge 100 as viewed from the drive side.

In the process cartridge 100 of this embodiment, the drum unit 120 (drum frame) supports one longitudinal end side of the developing unit 150 (developing frame) such that the developing unit 150 can swing about the axis b parallel to the rotation axis of the developing roller 103. Also, the drum unit 120 (drum frame) supports the other longitudinal end side of the developing unit 150 (developing frame) such that the developing unit 150 can swing about the axis b parallel to the rotation axis of the developing roller 103 and can move in the first direction (P direction in FIGS. 1 and 14) perpendicular to the axis b. The developing roller 103 is movable between a first position and a second position by the drum unit 120 (drum frame) swinging about the axis b relative to the developing unit 150 (developing frame) and also moving in the first direction (P direction). At the second position, the developing roller 103 is farther away from the photosensitive drum 101 than it is at the first position. At the first position, the developing roller 103 is in contact with the photosensitive drum 101 with the rotation axis of the photosensitive drum 101 being parallel to the rotation axis of the developing roller 103. At the second position, the developing roller 103 is separated from the photosensitive drum 101. A state in which the rotation axis of the photosensitive drum 101 is parallel to the rotation axis of the developing roller 103 and the photosensitive drum 101 is in contact with the developing roller 103 is referred to as a contact state. The first direction (P direction) is a direction parallel to a straight line connecting the rotation axis (center of rotation) a of the photosensitive drum 101 and the rotation axis (center of rotation) of the developing roller 103 in an imaginary plane perpendicular to the rotation axes of the photosensitive drum 101 and the developing roller 103 in the contact state (see FIG. 14). Details are given below.

As described above, the developing cover member 155 includes the cylindrical portion 155a (swing supported portion), which is supported in the developing unit support hole 122b of the drive-side cover member 122 (FIGS. 9 and 15). On the other hand, the non-drive-side bearing 154 includes the cylindrical portion 154g (swing supported portion), which is supported in the developing unit support hole 123b of the non-drive-side cover member 123 (FIG. 14). The cylindrical portion 155a of the developing cover member 155 is coaxial with the cylindrical portion 154g of the non-drive-side bearing 154.

The cross-sectional shape of the developing unit support hole 122b (swing support portion) of the drive-side cover member 122 is circular in cross section perpendicular to the rotation axis direction of the photosensitive drum 101. The cross-sectional shape of the developing unit support hole 123b (swing support portion) of the non-drive-side cover member 123 is an elongated hole in cross section perpendicular to the rotation axis direction of the photosensitive drum 101. This elongated hole is formed by two straight lines extending parallel to the first direction, a semicircle connecting one end of each of the straight lines, and a semicircle connecting the other end of each of the straight lines. As viewed in the direction of the rotation axis of the photosensitive drum 101, the developing unit support hole 123b (one of the swing support portion and the swing supported portion) is an elongated hole having a longitudinal direction in the first direction, and the cylindrical portion 154g (the other of the swing support portion and the swing supported portion) is a protruding portion that protrudes so as to engage with the elongated hole.

The cylindrical portion 155a is a cylindrical first projecting portion that extends from one end side of the developing frame in the rotational axis direction of the developing roller 103, and the cylindrical portion 155a forms a first supported portion. The cylindrical portion 154g is a cylindrical second projecting portion that extends from the other end side of the developing frame in the rotational axis direction of the developing roller 103, and the cylindrical portion 154g forms a second supported portion. The developing unit support hole 122b is a first support hole into which the cylindrical portion 155a can be fitted. The developing unit support hole 122b forms a first support portion that supports the cylindrical portion 155a such that the cylindrical portion 155a can rotate about the axis b, which is parallel to the rotation axis of the developing roller 103, with the cylindrical portion 155a fitted in the developing unit support hole 122b. The developing unit support hole 123b is a second support hole into which the cylindrical portion 154g can be fitted. The developing unit support hole 123b forms a second support portion that supports the cylindrical portion 154g such that the cylindrical portion 154g can rotate about the axis b, which is parallel to the rotation axis of the developing roller 103, and move in the first direction (P direction) with the cylindrical portion 154g fitted in the developing unit support hole 123b.

As a result, the developing frame (first developing frame 151, second developing frame 152) is coupled with the drum frame 121 such that the developing frame can rotate relative to the drum frame 121 and move in the first direction (P direction) with the process cartridge 100 attached to the apparatus main body 2. In other words, the developing unit 150 and the drum unit 120 are coupled such that the developing unit 150 can rotate and also move in the first direction relative to the drum unit 120 with the process cartridge 100 attached to the apparatus main body 2. The developing roller 103 is movable between the first position and the second position by the developing frame (developing unit 150) rotating relative to the drum frame 121 (drum unit 120) and also moving in the first direction (P direction). At the first position, the developing roller 103 is in contact with the photosensitive drum 101. At the second position, the developing roller 103 is separated from the photosensitive drum 101.

If the developing unit support holes 122b and 123b both have a circular cross section, any variations in the dimensions of the cylindrical portions 155a and 154g in the P direction may cause the rotation axes of the developing roller 103 and the photosensitive drum 101 to be non-parallel. In this case, at the first position, the developing roller 103 would fail to be uniformly in contact with the photosensitive drum 101 over its entire area in the rotation axis direction. This may degrade the quality of image formation. In some cases, a biasing member is provided to bias the developing roller 103 toward the photosensitive drum 101. In this case, if the rotation axis of the developing roller 103 is not parallel to the rotation axis of the photosensitive drum 101, the biasing force may deform the developing unit 150. This may cause the drum unit 120 to fail to stably support the developing unit 150.

In this embodiment, since the developing unit support hole 123b is an elongated hole that is elongated in the P direction, it is possible to accommodate dimensional variations in the P direction of the cylindrical portion 155a of the developing cover member 155 and the cylindrical portion 154g of the non-drive-side bearing 154. Specifically, even if the cylindrical portions 155a and 154g have dimensional variations in the P direction, the rotation axis of the developing roller 103 is parallel to the rotation axis of the photosensitive drum 101 when the cylindrical portion 154g is at a predetermined position in the first direction in the developing unit support hole 123b. In other words, the length in the first direction of the elongated hole of the developing unit support hole 123b is set such that the rotation axes of the developing roller 103 and the photosensitive drum 101 are parallel when the cylindrical portion 154g is at a position in the first direction of the developing unit support hole 123b. Here, the length of the elongated hole in the first direction can be determined taking into account the manufacturing tolerance of the components and the like. This limits deformation of the developing unit 150 in the P direction, allowing the developing unit 150 to be stably supported.

The position of the developing unit 150 relative to the drum unit 120 when the developing roller 103 and the photosensitive drum 101 are in the first position is defined as a contact position. The position of the developing unit 150 relative to the drum unit 120 when the developing roller 103 and the photosensitive drum 101 are in the second position is defined as a separated position. When the developing unit 150 is moved between the contact position and the separated position, motion occurs in which the cylindrical portion 154g moves in the first direction inside of the developing unit support hole 123b and comes into contact with either end in the first direction in the developing unit support hole 123b. Also, motion occurs in which the cylindrical portion 154g rotates within the developing unit support hole 123b and the cylindrical portion 155a rotates within the developing unit support hole 122b. The motion of rotation and the linear motion in the first direction move the developing unit 150 relative to the drum unit 120. Furthermore, since the developing unit 150 is movable in the P direction relative to the drum unit 120, the developing roller 103 can be brought into and out of contact with the photosensitive drum 101 with high efficiency of movement.

Additionally, the non-drive-side cover member 123 and the non-drive-side bearing 154 include spring-holding boss portions 123c and 154h, and a spring 169 is provided for stably pressing the developing roller 103 against the photosensitive drum 101. The spring 169 is an example of a biasing member having one end connected to the drum frame and the other end connected to the developing frame. The spring 169 applies a force to the drum frame and the developing frame so as to bias the developing roller 103 toward the photosensitive drum 101.

Referring to FIG. 1, the arrangement of the contact members in this embodiment is now described. The developing roller contact member 154b (first contact), the developing blade contact member 154d (second contact), and the supply roller contact member 154c (third contact) are arranged on an imaginary line extending in a second direction (S direction) perpendicular to the first direction (P direction). In FIG. 1, imaginary lines are indicated by reference letters SL. The widths in the first direction of the developing roller contact member 154b, the developing blade contact member 154d, and the supply roller contact member 154c are greater than the widths in the second direction. Also, as viewed in the direction of the rotation axis of the photosensitive drum 101, the developing blade contact member 154d (second contact) is located farther away from the cylindrical portion 154g (swing supported portion) than the developing roller contact member 154b (first contact) is. Furthermore, the width in the first direction of the developing blade contact member 154d (second contact) is greater than the width in the first direction of the developing roller contact member 154b (first contact). The first direction (P direction) is the direction in which the elongated hole of the developing unit support hole 123b extends. As shown in FIG. 1, at least a part of the developing blade contact member 154d and a part of the supply roller contact member 154c are within the region (indicated by diagonal lines) located between straight lines S1 and S2 extending in the S direction and passing through the outermost points in the P direction of the developing roller contact member 154b.

In this embodiment, the size of each contact member is set to satisfy the following.

Width in P direction>dimension in P direction of electrode of apparatus main body+component tolerance variation+movement amount of developing unit 150 Width in S direction>dimension in S direction of electrode of apparatus main body+component tolerance variation

The movement amount of the developing unit 150 refers to the amount of movement caused by the linear motion in the first direction (P direction) and the rotation about the axis b of the developing unit 150 that occur when the position of the developing unit 150 moves between the contact position and the separated position relative to the drum unit 120. As described above, the developing unit 150 moves relative to the drum unit 120 by linear motion in the first direction (P direction) and rotation about the axis b. The length of each contact member in the first direction is determined by adding a length for taking into account variations due to component tolerances to the combined length of the length in the first direction of the electrode of the apparatus main body corresponding to the contact member, the length of possible movement in the first direction by linear motion, and the length of possible rotation about the axis b. The electrode of the apparatus main body corresponding to the contact member is an electrode provided on the apparatus main body 2 such the electrode can come into contact with the contact member with the process cartridge 100 attached to the apparatus main body 2. The electrode is biased towards the process cartridge 100 by a spring, for example, and therefore comes into contact with the contact member when the process cartridge 100 is attached. For example, with the process cartridge 100 attached to the apparatus main body 2, the electrode of the apparatus main body 2 corresponding to the developing roller contact member 154b comes into contact with the developing roller contact member 154b, thereby supplying electricity to the developing roller 103 via the developing roller contact member 154b. By setting the size of the contact member as described above, even if the developing unit 150 moves relative to the drum unit 120, the electrode (for example, a contact spring) of the apparatus main body 2 is unlikely to drop from the contact member on the process cartridge side. This enables stable power supply from the apparatus main body 2 to the process cartridge 100.

Additionally, multiple contact members each having a width narrower in the S direction than in the P direction are arranged such that the imaginary line SL1 parallel to the second direction passes through these contact members. As such, it is possible to reduce the space required to arrange the multiple contact members. According to this embodiment, it is possible to arrange the contact members in a space-saving manner while ensuring that the contact members are sized to limit dropping of the electrode of the apparatus main body 2 from the contact member when the developing unit 150 moves relative to the drum unit 120.

In the present embodiment, the three contact members, the supply roller contact member 154c, the developing blade contact member 154d, and the developing roller contact member 154b, are arranged such that the imaginary line SL1 parallel to the second direction passes through them, but the present invention is not limited to this example. The same advantageous effects can be achieved by arranging at least two contact members among the supply roller contact member 154c, the developing blade contact member 154d, and the developing roller contact member 154b such that the imaginary line SL1 parallel to the second direction passes through them.

In this embodiment, the first detection contact member 154e and the second detection contact member 154f are arranged such that the imaginary line SL2 parallel to the second direction passes through them (FIG. 1). Specifically, as shown in FIG. 1, at least a part of the first detection contact member 154e is within the region (indicated by diagonal lines in FIG. 1) between straight lines S3 and S4 extending in the S direction and passing through the outermost points in the P direction of the second detection contact member 154f. This achieves reduction in the installation space for the first and second detection contact members 154e and 154f in the developing unit 150. The arrangement of the first and second detection contact members 154e and 154f is not limited to this.

In this embodiment, as shown in FIG. 1, the spring 169, the supply roller contact member 154c, the developing blade contact member 154d, and the developing roller contact member 154b are arranged such that the imaginary line SL1 parallel to the second direction passes through them. This achieves reduction in the installation space for the spring 169, the supply roller contact member 154c, the developing blade contact member 154d, and the developing roller contact member 154b in the developing unit 150. The arrangement of the spring 169 is not limited to this.

As viewed in the direction of the rotation axis, the developing roller contact member 154b, the developing blade contact member 154d, and the supply roller contact member 154c are arranged in this order from the one closest to the developing roller 103 with the process cartridge 100 attached to the apparatus main body 2. As described above, the developing roller contact member 154b is connected to the developing roller support portion 154b1 through the flow passage portion 154b3. The supply roller contact member 154c is connected to the supply roller support portion 154c1 through the flow passage portion 154c3. The developing blade contact member 154d is connected to the developing blade contact spring support portion 154d1 through the flow passage portion 154d3. Since the supply roller contact member 154c, the developing blade contact member 154d, and the developing roller contact member 154b are formed by two-color molding, it is preferable that the total length of the flow passage portions 154b3, 154c3, and 154d3 be short. The contact members are preferably arranged so as to minimize the total length of the flow passage portions 154b3, 154c3, and 154d3 in accordance with the layout of the developing roller 103, the supply roller 104, the developing blade 156, and the electrodes of the apparatus main body 2. In the present embodiment, the total length of the flow passage portions 154b3, 154c3, and 154d3 is reduced by arranging the contact members in the order of supply roller contact member 154c, developing blade contact member 154d, and developing roller contact member 154b in the vertical direction.

According to this embodiment, as viewed in the axial direction of the developing roller 103, multiple contact members are arranged such that the imaginary line SL1 parallel to a direction (S direction) perpendicular to the moving direction (P direction) of the developing unit 150 passes through them, allowing the contact members to be arranged in a space-saving manner.

In the above embodiment, an example is described in which the present invention is applied to a process cartridge that is attachable to and detachable from the apparatus main body through a cartridge tray that is movable between the outside position at which the cartridge tray is pulled out of the apparatus main body and the inside position at which the cartridge tray is housed in the apparatus main body. However, the present invention is not limited to this. The present invention is also applicable to a process cartridge that can be directly attached to and detached from the apparatus main body of an image forming apparatus that does not include a cartridge tray.

Also, although an example is described in which the present invention is applied to a process cartridge including a developing unit and a drum unit, the embodiment of the present invention is not limited to this. For example, the present invention is also applicable to a developing cartridge that is attachable to and detachable from the apparatus main body of an image forming apparatus that includes a photosensitive drum. In this case, the apparatus main body includes the photosensitive drum and swing support portions. The configuration of this swing support portions is similar to that of the developing unit support hole 122b and the developing unit support hole 123b in the above embodiment, but differs from the above embodiment in that the apparatus main body includes these swing support portions. The developing cartridge includes a developing roller, a process member configured to act on the developing roller, and a developing frame that rotatably supports the developing roller. The developing cartridge includes a swing supported portion supported by the swing support portion of the apparatus main body such that the developing roller can swing between a first position and a second position that is farther away from the photosensitive drum than the first position is. The configuration of the developing cartridge is similar to that of the developing unit 150 in the above embodiment, but differs from the above embodiment in that it is swingably supported by the apparatus main body. A first contact and a second contact for the developing roller and the process member to individually receive power supply from outside of the developing cartridge are provided on an end surface of the developing cartridge in the direction of the rotation axis of the photosensitive drum. The first contact is similar to the developing roller contact member 154b in the above embodiment, and the second contact is similar to the developing blade contact member 154d and the supply roller contact member 154c. As viewed in the direction of the rotation axis, one of the swing support portion and the swing supported portion (the developing unit support hole 123b) is an elongated hole having a longitudinal direction in the first direction, and the other (cylindrical portion 154g) is a protruding portion that protrudes so as to engage with the elongated hole. These configurations are similar to those in the above embodiment. As viewed in the direction of the rotation axis, the first and second contacts are arranged on an imaginary line extending in the second direction perpendicular to the first direction. Also, the first contact (developing roller contact member 154b), the second contact (developing blade contact member 154d), and the third contact (supply roller contact member 154c) may be arranged on an imaginary line extending in the second direction. The width of the contact member in the first direction is greater than the width in the second direction. These configurations are also similar to those in the above embodiment. Also, as viewed in the direction of the rotation axis, the first contact (developing roller contact member 154b), the second contact (developing blade contact member 154d), and the third contact (supply roller contact member 154c) may be arranged in this order from the one closest to the developing roller. The swing support portion and the swing supported portion may be provided on the end surface at the side where the first and second contacts are provided in the direction of the rotation axis. The present invention is also applicable to a configuration including a first conductor and a second conductor forming a remaining amount detection portion in a storage portion storing developer in a developing frame. In this case, a fourth contact and a fifth contact for the first conductor and the second conductor to individually receive power supply from outside of the process cartridge are provided. As viewed in the direction of the rotation axis, the fourth and fifth contacts may be arranged on an imaginary line extending in the second direction. In a configuration in which the photosensitive drum is movable between the first position and the second position when the developing cartridge moves relative to the apparatus main body, the above configuration allows the developing roller contact member, the supply roller contact member, and the developing blade contact member to be arranged in a space-saving manner.

According to the present disclosure, in a process cartridge or a developing cartridge in which a developing roller is movable between a contact position and a separated position relative to a photosensitive drum, it is possible to arrange a developing roller contact member and a process member contact member in a space-saving manner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057829, filed on Mar. 29, 2024, which is hereby incorporated by reference herein in its entirety.

What is claimed is:

1. A process cartridge comprising:
a drum unit including a photosensitive drum, a drum frame that supports the photosensitive drum such that the photosensitive drum is rotatable about a rotation axis, and a swing support portion;
a developing unit including a developing roller, a process member configured to act on the developing roller, a developing frame that rotatably supports the developing roller, and a swing supported portion supported by the swing support portion of the drum unit such that the developing roller can swing between a first position and a second position that is farther away from the photosensitive drum than the first position is; and
a first contact for the developing roller to receive power supply from outside of the process cartridge and a second contact for the process member to receive power supply from outside of the process cartridge, the first contact and the second contact being provided on an end surface of the process cartridge in a direction of the rotation axis,
wherein one of the swing support portion and the swing supported portion is an elongated hole having a longitudinal direction in a first direction as viewed in the direction of the rotation axis and the other of the swing support portion and the swing supported portion is a protruding portion that protrudes so as to engage with the elongated hole,
wherein the first contact and the second contact are arranged on an imaginary line extending in a second direction perpendicular to the first direction as viewed in the direction of the rotation axis, and
wherein the first contact has a width that is greater in the first direction than in the second direction and the second contact has a width that is greater in the first direction than in the second direction.

2. The process cartridge according to claim 1, wherein the process member is a developing blade configured to regulate a layer thickness of developer carried on a surface of the developing roller.

3. The process cartridge according to claim 1, wherein the process member is a supply roller configured to supply the developer to the developing roller.

4. The process cartridge according to claim 2,
wherein the developing unit includes a supply roller configured to supply the developer to the developing roller, and
wherein the process cartridge includes a third contact for the supply roller to receive power supply from outside of the process cartridge provided on the end surface of the process cartridge, the third contact being arranged on the imaginary line as viewed in the direction of the rotation axis and having a width that is greater in the first direction than in the second direction.

5. The process cartridge according to claim 4, wherein the first contact, the second contact, and the third contact are arranged in this order from the one closest to the developing roller as viewed in the direction of the rotation axis.

6. The process cartridge according to claim 1, wherein the swing support portion and the swing supported portion are provided in an end portion of the process cartridge on a side where the end surface is located in the direction of the rotation axis.

7. The process cartridge according to claim 1, wherein the second contact is located farther away from the swing supported portion than the first contact is as viewed in the direction of the rotation axis, and has a width in the first direction that is greater than a width of the first contact in the first direction.

8. The process cartridge according to claim 1, wherein the first contact and the second contact are made of a conductive resin.

9. The process cartridge according to claim 1,
wherein the swing support portion includes a first support hole that is provided at one end side in the direction of the rotation axis and is circular in a cross section perpendicular to the rotation axis, and a second support hole that is provided at the other end side in the direction of the rotation axis and is an elongated hole that is elongated in the first direction in a cross section perpendicular to the rotation axis,
wherein the swing supported portion includes a first supported portion that is provided at the one end side in the direction of the rotation axis and is swingably supported by the first support hole, and a second supported portion that is provided at the other end side in the direction of the rotation axis and is supported by the second support hole such that the second supported portion can swing and also move in the first direction, and
wherein each of the first contact and the second contact has a length in the first direction longer than a combined length of a length in the first direction of an electrode of an apparatus main body, a length in the first direction of the elongated hole of the second support hole, and a length by which the developing frame can swing relative to the drum frame.

10. The process cartridge according to claim 9, wherein the developing roller has a rotation axis parallel to the rotation axis of the photosensitive drum when the second supported portion is at a position in the first direction in the second support hole.

11. The process cartridge according to claim 1, wherein the first direction is parallel to a straight line in an imaginary plane perpendicular to the rotation axis, the straight line connecting a rotation axis of the developing roller and the rotation axis of the photosensitive drum in a state in which the rotation axis of the developing roller is parallel to the rotation axis of the photosensitive drum and the developing roller is in contact with the photosensitive drum.

12. The process cartridge according to claim 1,
wherein the developing unit includes a storage portion configured to store developer, and a detection portion including a first conductor and a second conductor provided inside of the storage portion and configured to detect a remaining amount of developer in the storage portion,
wherein the process cartridge includes a fourth contact for the first conductor to receive power supply from outside of the process cartridge and a fifth contact for the second conductor to receive power supply from outside of the process cartridge provided on an end surface of the process cartridge in the direction of the rotation axis, the fourth contact and the fifth contact being arranged on an imaginary line extending in the second direction as viewed in the direction of the rotation axis.

13. The process cartridge according to claim 1,
wherein the process cartridge includes a biasing member, one end of the biasing member being connected to the drum frame and the other end of the biasing member being connected to the developing frame, and the biasing member being configured to apply a force to the drum frame and the developing frame so as to bias the developing roller toward the photosensitive drum, and
wherein the biasing member, the first contact, and the second contact are arranged on an imaginary line extending in the second direction.

14. A developing cartridge attachable to and detachable from an apparatus main body of an image forming apparatus including a photosensitive drum and a swing support portion, the developing cartridge comprising:
a developing unit including a developing roller, a process member configured to act on the developing roller, a developing frame that rotatably supports the developing roller, and a swing supported portion supported by the swing support portion of the apparatus main body such that the developing roller can swing between a first position and a second position that is farther away from the photosensitive drum than the first position is; and
a first contact for the developing roller to receive power supply from outside of the developing cartridge and a second contact for the process member to receive power supply from outside of the developing cartridge, the first contact and the second contact being provided on an end surface of the developing cartridge in a direction of a rotation axis of the photosensitive drum,
wherein one of the swing support portion and the swing supported portion is an elongated hole having a longitudinal direction in a first direction as viewed in the direction of the rotation axis and the other of the swing support portion and the swing supported portion is a protruding portion that protrudes so as to engage with the elongated hole,
wherein the first contact and the second contact are arranged on an imaginary line extending in a second direction perpendicular to the first direction as viewed in the direction of the rotation axis, and
wherein the first contact has a width that is greater in the first direction than in the second direction and the second contact has a width that is greater in the first direction than in the second direction.
